(19) United States
(12) Patent Application Publication
(10) Pub. No.: US 2003/0230555 A1
(43) Pub. Date: Dec. 18, 2003

(54) Method and device for producing a hollow profile

(75) Inventor: Ralf Kummle, Schopfheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Dreistern-Werk Maschinenbau GmbH & Co. KG, Schopfheim (DE)

(21) Appl. No.: 10/462,516

(22) Filed: Jun. 16, 2003

(30) Foreign Application Priority Data
Jun. 14, 2002 (DE) 102 26 517.8

(51) Int. Cl. B23K 31/02; B23Q 15/00

(52) U.S. Cl. 219/121.63; 219/121.64; 228/102; 228/9; 228/164

(57) ABSTRACT

A process and a device for producing a hollow profile with a cross section varying along its length is provided, in which a first metal strip, varying in width, is deformed by a plurality of driven or free-running roller shaping tools to an open profile, after which the profile passes through a welding station. In the welding station, a second metal strip is brought together with the open profile and is laid flush on the edges bounding the open side. The two components, one laid on the other, are then welded longitudinally to form the desired hollow profile.

### BACKGROUND

The invention relates to a method and a device for producing a hollow profile with a cross section varying along its length.

In contrast to hollow profiles with constant a cross section, hollow profiles of the above-mentioned kind are not produced in a continuous work process. On the contrary, round or polygonal tubes, seamless or else welded, are first produced in the desired length. These are then deformed by an internal high pressure deformation process into hollow profiles whose cross section does not remain constant, but changes along the longitudinal axis of the hollow profile.

This production method according to the prior art for hollow profiles of the above-mentioned type is thus not a continuous process, but the workpieces have to be converted piecewise into their final form.

Correspondingly, the process step of internal high pressure deformation contributes considerably to the production costs, since the handling of workpieces which are deformed one piece at a time is quite expensive, even with the use of industrial robots.

### SUMMARY

The present invention therefore has as its object to provide a method and a device for producing a hollow profile with a cross section varying along its length, by which the production of such hollow profiles is quicker and more efficient, and hence cost-effective.

This object is attained with a method according to the invention and with a device also provided by the invention. A welding station for use in the method according to the invention is also provided.

The invention is thus based on the knowledge that even hollow profiles with varying cross section can be produced continuously, and in fact with a profiling machine which comprises a plurality of deforming stations with roller shaping tools, arranged in line one behind the other, and also a welding station.

The principle of such a profiling machine is known, for example, from the Applicant's DE 198 34 400 C1. The profiling machine described therein has a plurality of deforming stations in which roller shaping tools, respectively cooperating pairwise for the stepwise deformation of a metal strip in a continuous deformation process, are mounted, driven or free-running, in frames. The metal strip, deformed into a hollow profile, thereafter runs through a welding station, arranged in-line, in which the bent-together edges of the metal strip are butt-welded together. This profiling machine, known per se, is very efficient because of the continuous production process and makes possible the cost-effective mass production of hollow profiles. A change of a hollow profile with varying cross section however requires a complete resetting of the machine, even when the roller shaping tools are displaceable in their frames. A continuous production of a hollow profile with varying cross section, as provided according to the invention, was certainly excluded in the prior art with profiling machines as known from DE 198 34 400 C1.

As already mentioned, the present invention, in contrast to the possibilities heretofore, starts from the central concept that under given conditions a hollow profile with a cross section varying along its length can be produced on a correspondingly adapted profiling machine with roller shaping tools, and in fact in that a metal strip with a width varying along its length is deformed in the roller shaping tools into an open profile, and thereafter a second metal strip is laid onto the edges bounding the open side of the open profile, and finally the second metal strip is welded to the open profile to form a hollow profile. The hollow profile is thus not produced from a single metal strip but from two metal strips; at least the first metal strip varies in its width corresponding to the desired course of the cross section of the finished profile, and is thus not provided as usual with parallel running edges. The deformation of the first metal strip does not take place completely as far as a hollow profile, which in general will also not be possible because of its varying width, but by the welding of a second metal strip on the “gap” of the open profile produced by roller deformation. The roller deformation and the welding expediently take place in a continuous process, in that the process steps according to the invention are performed in line one after another.

The first metal strip used does not necessarily have edges running symmetrically on both sides. It is possible, for example, to provide only one side of the metal strip with an edge differing from a straight line, so that the desired varying course of cross section can be produced by welding the second metal strip onto this “varying” edge. However, it will usually be reasonable to shape a more or less U-shaped profile with side cheeks varying symmetrically in their height and onto which the second metal strip is welded as a cover sheet. By this means, a hollow profile results with the desired course of cross section.

The invention thus for the first time makes usable the efficiency and production speed of a profiling machine with roller shaping tools also for the production of a hollow profile with varying cross section. The cost advantages provided in particular by mass production are hereby made available.

Welding is preferably performed with laser welding equipment which makes possible welding with pinpoint accuracy together with high positional variability of the place of action. The laser radiation is here preferably directed substantially perpendicularly of the longitudinal axis of the open profile onto the contact regions between the open profile and the second metal strip. The laser radiation can hereby act with relatively low intensity on the whole contact region to be welded.

Since hollow profiles are produced according to the invention, having a cross section which does not remain constant, it is particularly advantageous if the welding device is designed so that the position of its place of action can be changed, since only then can the welding head(s) be caused to follow a more or less wavy course of the edges to be welded during continuous transport of the profile through the welding station. As a result, expensive mechanisms are unnecessary which would ensure that the weld seam to be produced is passed exactly in a straight line to the corresponding welding head.

The corresponding design of the welding station with a welding device which is changeable in position as with respect to its location of action also comprises, according to the invention, a sensing device for detecting the present position of at least one of the contact places between the open profile and the second metal strip. This sensing device can in particular be provided electronically, optically or mechanically, and expediently controls the welding device so that its location of action is always directed exactly onto the edges to be welded, independently of their varying instantaneous position during transport of the hollow profile. A sensing device can be provided here for each weld seam to be produced; with U-shaped profiles with side cheeks which correspond in their shape right and left, it is also possible, for example, to use only one sensing device for both weld seams to be produced, even when in this case preferably two welding heads are used, arranged right and the left of the hollow profile.

A mechanical sensing device for controlling the movement of the welding device is particularly reliable, robust and easy to implement. It can be provided, in particular, to use a roller which rolls on the second metal strip laid on the open profile, and thereby senses the present course of the edge to be welded, and transmits it to the welding device.

Such a roller has the advantage that the relative speed of the edge to be welded and the welding device can be detected in the simplest manner, this quantity preferably being used for controlling the welding power. As is immediately clear, the relative speed of the edge to be welded and the welding device is greater when this edge does not run in a straight line through the welding station but deviates from the longitudinal axis of the hollow profile, so that the welding head or welding heads have to make a movement perpendicularly of the direction of advance of the profile.

The second metal strip is preferably laid on the open profile by a guide roller device, so that it can immediately be laid on the more or less wavy course of the edges of the open profile to be welded. A further great advantage of the present invention then results in that such a guide roller device can simultaneously serve as a sensing device, and in fact with or without control of the welding power. A spring-loaded guide roller device can for example be provided for this purpose, and controls the displacement of a welding device which is displaceable perpendicularly of the longitudinal axis of the profile. This is particularly simple when one or more welding heads of the welding device are directly fastened to the guide roller device. This leads to a particularly simple and compact welding station for hollow profiles with varying cross sections.

Further advantages result for the method according to the invention when different materials are used for the first and second metal strips. A kind of composite hollow profile with varying cross section thus results, which offers heretofore unknown possibilities regarding its stability and weight distribution.

The second metal strip can also be provided with stampings and/or bent-up portions. This development of the method according to the invention thus makes it possible to apply functional elements of a finished hollow profile in the simplest manner during its actual production, without having to correspondingly further process the finished profile.

### BRIEF DESCRIPTION OF THE DRAWINGS

An exemplary embodiment of the invention is described and explained in detail using the accompanying drawings.

FIG. 1 shows a schematic side view of a device according to the invention;

FIG. 2 shows a schematic view of a welding station for use in the present invention;

FIG. 3 shows a hollow profile produced according to the invention.

### DETAILED DESCRIPTION OF THE PREFERRED EMBODIMENTS

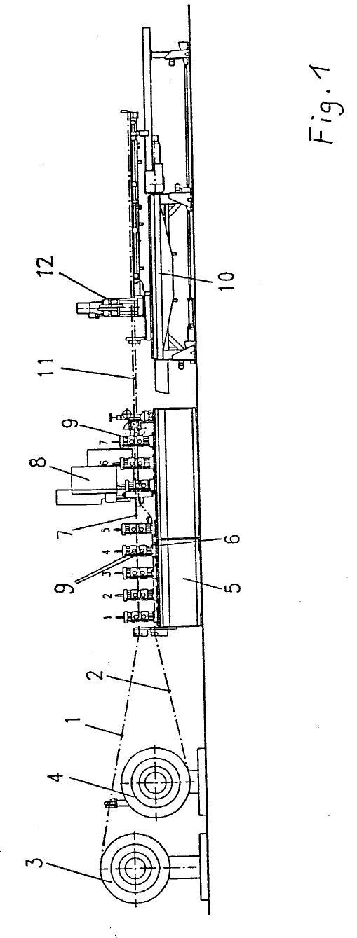

In FIG. 1, which is a schematic side view, the structure of an exemplary embodiment of the device according to the invention is shown. A first metal strip 1, varying in width, and a second metal strip 2 provided with parallel longitudinal edges, are taken for the continuous production process from a first supply reel 3 and a second supply reel 4. The first metal strip 1 passes through a deformation position 5, here shown with five frames 6, in which respectively a pair of cooperating roller shaping tools 9, which are driven or free-running, effect a stepwise deformation of the first metal strip 1 into an open profile 7. The second metal strip 2 is guided past the roller shaping tools 9 and transported together with the shaped open profile 7 through a welding station 8. The second metal strip 2 is there laid flush on the open side of the profile 7, as described in detail below, and is welded to it. Following the welding station 8, a further two frames with roller shaping tools 9 are passed through in order to straighten the hollow profile produced in the welding station 8. The finished hollow profile 11 leaving this straightening station has a cross section varying along its length according to the invention and is then cut to the desired lengths in a cutting-off machine 10 with traveling shears 12.

As can be clearly seen from FIG. 1, a continuous process is thus concerned in the method according to the invention, with which a cost-effective and rapid mass production of profiles with varying cross section is possible.

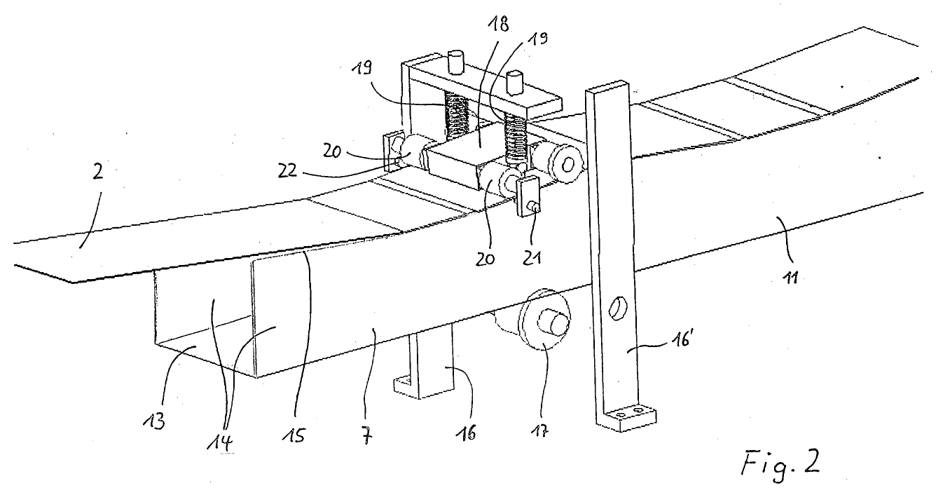

FIG. 2 shows, in a purely schematic diagram, the most important functional elements of the welding station 8. The open profile 7, which is shaped as a U-shaped profile with a flat base 13 bounded by edges running parallel and two side cheeks 14 whose upper boundary edges 15 have an wavy course which is identical on the right and left, is continuously guided through the welding station by means of a driven guide roller 17 mounted in a frame 16, so that the second metal strip 2 is laid flush with the edges 15 and is positioned by means of a guide roller device 18 for welding. The guide roller device 18 is not driven and is prestressed against the second metal strip 2 by two springs 19, so that, cooperating with the guide roller 17, it makes sure of a clean abutment of the second metal strip 2 on the edges 15 of the open profile 7.

The contact surface between the profile 7 and the second metal strip 2 is thus defined by the lower surface of the second metal strip 2, so that the instantaneous position of the front rollers 20 of the guide roller device respectively represents the exact location of the weld seam to be produced. These rollers 20 furthermore take the instantaneous total speed of the second metal strip 2 and thus of the edge 15 of the profile 7, which is composed of the speed of advance of the profile 7 and the movement of the guide roller device 18 running perpendicular of the longitudinal axis of the profile 7. The rotational speed of the rollers 20 is used for controlling the welding power.

A first and a second welding head 21, 22 are fastened to the shaft of the rollers 20, on the ends of the front rollers 20 of the guide roller device 18, and focus a respective laser beam on the contact region between the edge 15 of the profile 7 and the metal strip 2. With this manner of arrangement of the welding heads 21, 22, the guide roller device 18 automatically transfers the varying contour of the profile 7 to the welding heads 21, 22, so that these very exactly follow the edge 15 of the profile 7.

For an understanding of FIG. 2, it should be noted that the frame 16 is only schematically shown so that the functionally important parts of the welding station can be better seen, the front portion 16′ of the frame having been removed from its built-in position.

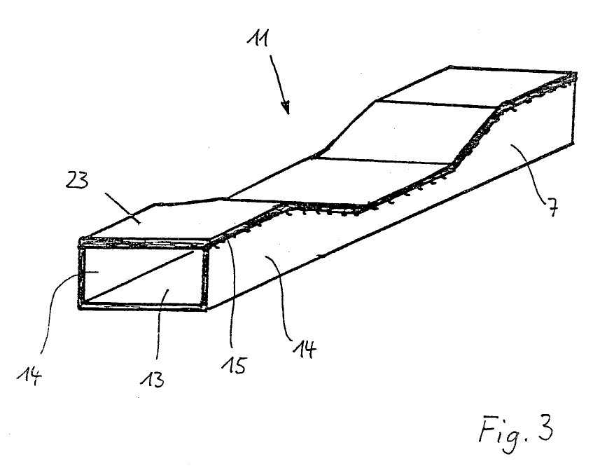

The hollow profile 11 with varying cross section leaving the welding station 8 shown in FIG. 2 can again be seen in FIG. 3. A portion of the hollow profile 11 cut to length by the cutting-off machine 10 is concerned, formed of a U-profile 7 with wavy side cheeks 14 and a cover strip 23 laid onto and welded to the side cheeks.

The geometry shown in FIG. 3 can be produced very easily, in that the first metal strip either has a prefabricated, varying width, or else has a contour of the longitudinal edges of the strip stamped into it by a pre-stamping device arranged in the line after the coil, corresponding to the different final heights of the U-profile 7. The deformation position 5 effects the deformation of the first metal strip 1 to the U-profile 7; lateral strip guiding may be ensured by means of spring-mounted side rollers. The cover strip 23, continuously supplied during the process in the form of a second metal strip 2, is welded in the welding station 8 to the edges 15, which run in a wave shape, of the side cheeks 14, the welding power on the sections running purely horizontally of the hollow profile shown here being chosen lower than on the ramp-shaped sections which in the continuous throughflow process of course have a higher speed relative to the welding device than the horizontal sections.

Reference List

| | |
|---|---|
| 1 | metal strip (first) |
| 2 | metal strip (second) |
| 3 | supply coil (first) |
| 4 | supply coil (second) |
| 5 | deforming device |
| 6 | frame |
| 7 | profile |
| 8 | welding station |
| 9 | roller shaping tools |
| 10 | cutting-off machine |
| 11 | hollow profile |
| 12 | shears |
| 13 | base (of 7) |
| 14 | side cheeks (of 7) |
| 15 | edges (of 7) |
| 16 | frame |
| 17 | guide roller |
| 18 | guide roller device |
| 19 | springs |
| 20 | rollers |
| 21 | welding head (first) |
| 22 | welding head (second) |
| 23 | cover strip |

1. Method for producing a hollow profile with a cross section varying along its length, comprising the following process steps:
deforming a first metal strip (1) with a width varying along a length thereof to an open profile (7) using roller shaping tools (9);
laying a second metal strip (2) on edges (15) bounding an open side of the open profile (7);
welding the second metal strip (2) to the open profile (7) to form a hollow profile (11).

2. Method according to claim 1, wherein the process steps are performed in a continuous process in line one after the other.

3. Method according to claim 2, wherein the welding takes place by laser radiation.

4. Method according to claim 3, wherein the laser radiation is directed substantially perpendicularly of a longitudinal axis of the open profile (7) onto contact regions between the open profile (7) and the second metal strip (2).

5. Method according to claim 2, wherein the second metal strip (2) is laid on the open profile (7) by a guide roller device.

6. Method according to claim 5, wherein a welding device (21, 22) displaceable substantially perpendicularly to the longitudinal axis of the profile (7) is used.

7. Method according to claim 6, wherein a spring-loaded guide roller device (18) is used, which controls the. displacement of the welding device (21, 22).

8. Method according to claim 6, wherein welding power is controlled in dependence on a relative speed between the edges to be welded and the welding device.

9. Method according to claim 8, wherein the welding power is controlled based on a rotational speed of a roller (20) rolling on the laid-on second metal strip (2).

10. Method according to claim 1, wherein different materials are used for the first and the second metal strips.

11. Method according to claim 1, wherein the second metal strip is provided with stampings and/or bent-up portions before being laid on the open profile.

12. Device for the production of a hollow profile with cross section varying along a length thereof, comprising:
a deforming device (5) with plural driven or free-running roller shaping tools (9) for deforming a first metal strip (1) into an open profile (7),
a welding station (8) with guide elements (17, 18) for bringing together the open profile (7) with a second metal strip (2), and a welding device (21, 22) for welding the second metal strip (2) with the open profile (7) to form a hollow profile (11),
the deforming device (5) being provided such that it is suitable for deforming a first metal strip (1) with a width varying along its length.

13. Device according to claim 12, wherein the welding device is laser welding equipment.

14. Device according to claim 13, wherein laser radiation from the laser welding equipment is directed substantially perpendicularly to a longitudinal axis of the open profile (7) onto contact regions between the open profile (7) and the second metal strip (2).

15. Device according to claim 12, wherein a sensing device (18, 20) is located in the welding station for detecting a present position of at least one of the contact regions between the open profile (7) and the second metal strip (2), and wherein the welding device (21, 22) is moveable in position with respect to a location of action, the sensing device (18, 20) being operatively connected to the welding device (21, 22) for movement control.

16. Device according to claim 15, wherein the sensing device (18, 20) comprises a roller (20) which rolls on the second metal strip (2) laid on the open profile (7).

17. Device according to claim 16, wherein the roller (20) comprises a guide roller.

18. Device according to claim 16, wherein welding power of the welding device is controllable in dependence on a rotational speed of the roller (20).

19. Device according to claim 15, wherein the sensing device (18, 20) is formed by a guide roller device (18) for bringing together the open profile (7) and the second metal strip (2).

20. Device according to claim 19, wherein the welding device contains at least one welding head (21, 22), which is mounted on the guide roller device (18).

21. Device according to claim 19, wherein the guide roller device (18) is spring-loaded and is movable substantially perpendicularly to a longitudinal axis of the profile (7).

22. A welding station for use in the method according to claim 1, comprising:
a transport and guiding device (17, 18) for bringing together an open metal profile (7) and a second metal strip (2) and for laying the second metal strip (2) on edges (16) bounding an open side of the open profile (7),
a welding device (21, 22) for welding the second metal strip (2) to the open profile (7) to form a hollow profile (11),
a sensing device (20) for detecting a present position of at least one contact region between the open profile (7) and the second metal strip (2),
the welding device (21, 22) being moveable in position with respect to a location of action, and the sensing device (20) being operatively connected to the welding device (21, 22) for movement control.
